(19) United States
(12) Patent Application Publication
(10) Pub. No.: US 2020/0141733 A1
(43) Pub. Date: May 7, 2020

(54) SYSTEM TO MEASURE ORIENTATION AND DIRECTION OF A VEHICLE, USUALLY AN UNMANNED AERIAL SYSTEM

(71) Applicant: NDSU Research Foundation, Fargo, ND (US)

(72) Inventor: Simone A. Ludwig, Fargo, ND (US)

(21) Appl. No.: 16/672,097

(22) Filed: Nov. 1, 2019

Related U.S. Application Data
(60) Provisional application No. 62/754,192, filed on Nov. 1, 2018.

(51) Int. Cl. G01C 21/16

(52) U.S. Cl. CPC G01C 21/16

(57) ABSTRACT

A system for navigation comprising a computing machine having a plurality of computing cores, a plurality of digital processing cores, a plurality of memory and a plurality of Magnetic and Inertial measurement Units is described. Also described are methods for navigation comprising receiving by a computing machine having a plurality of computing cores, accelerometer, gyroscope, and magnetometer data of a plurality of Magnetic and Inertial measurement Units (MIMUs) positioned to form a sensor array and fusing the data using a Madgwick filter, a Mahony filter, a Kalman filter and/or an extended Kalman filter to obtain an orientation value.

### RELATED APPLICATIONS

This application claims priority from U.S. Provisional Patent Application No. 62/754,192 filed on Nov. 1, 2018, the entire disclosure of which is incorporated herein by this reference.

### TECHNICAL FIELD

The present disclosure is directed to a system of navigation as well as a method for navigation containing a plurality of computing cores.

### BACKGROUND AND SUMMARY

Research around localization of objects and people has received significant attention in the past few decades and numerous techniques have been proposed to achieve high accuracy localization. Although GPS is the most common technology to provide accurate location for outdoor environments, it suffers from signal blocking and the multipath effect.

These effects lead to significantly lower location accuracy during the localization process. Thus, other alternative sensor measuring techniques have to be applied and improved in order to cover or replace GPS technology.

Micro-electromechanical inertial measurement units (MEMS IMU) are widely used as a low-cost option of attitude determination and short-term position tracking through dead reckoning. However, without frequent corrections from a positional tracking system, such as GPS, they suffer from large drifts due to noise and repeated integrations of linear and rotational accelerations.

Traditionally, multi-sensing systems have relied on complicated geometries. The main reason of having redundant sensors is to provide highly reliable and accurate sensor data and also reconfigure sensor network systems if some sensors failed. These two reasons provide the foundation for the design of fault-tolerant navigation systems in order to achieve reliability and integrity of inertial navigation systems [2], [3].

When considering the sensor shape configuration, past research identified two main approaches: orthogonal and non-orthogonal configuration. The non-orthogonal configuration uses a skewed setup whereby the measurement sensed by one sensor can be decomposed into three components along the orthogonal axes. The use of the non-orthogonal configuration has shown needing fewer sensors with the same accuracy compared to the orthogonal configuration that has been traditionally used in fault-tolerant navigation system [4].

Current optimization approaches involve factory calibration and this increases the cost of an MIMU substantially (as quoted in [5] the costs are around $1,000 per unit). Therefore, adding additional sensor triads or sensor arrays is economically viable if expensive calibration can be avoided. As a comparative figure, the cost of additional IMUs per unit is about $150 per sensor array, in small volume.

One problem of low-cost sensors is that they are prone to large systematic errors (e.g., biases, scale factors, drifts), which limit their applicability even in integrated navigation systems. Thus, redundant sensors offer the possibility to efficiently enhance the navigation performances and particularly the orientation. First experiments undertaken have shown an improvement of navigation performance ranging from 30% to 50% when 4 sensors instead of 1 sensor are used [6].

Although experimental results have demonstrated that redundant MEMS-IMUs integrated with GPS are an efficient way to improve navigation performances, the precise relationship between the number of sensors employed and the accuracy enhancement remains unclear [7]. Though simulations and experimental results have demonstrated that redundant sensors improve navigation performance [8]-[11], none of the work offers guidance as to how many sensors are required in order to meet certain specification and accuracy. Thus, more extensive simulation experiments are needed to analyze the improved accuracy as well as to analyze the execution time with increasing numbers of sensors.

Attitude Representation

With regards to the attitude representation, there are two different frames involved. One frame corresponds to the x, y, and z-axis of the object/device the MIMU is mounted on, referred to as OF(OFₓ, OF_{y}, OF_{z}), and the second frame represents the Earth frame, referred to as EF(EFₓ, EF_{y}, EF_{z}). In order for the tracking of objects to work, these two frames need to be aligned.

The attitude can be expressed by three different representations [8]. These are Euler angles (roll, pitch, yaw), rotation matrix, or quaternion. A unit-norm quaternion, which essentially defines the rotation between EF and OF is defined as [9]:

$$q = {S}_{{E}_{q }} = [ \begin{matrix}{q}_{0} \\ \vec{q}\end{matrix} ] = {[ \begin{matrix}{q}_{0} & {q}_{1} & {q}_{2} & {q}_{3}\end{matrix} ]}^{T} ∈ {4}^{} \qquad ( 1 )$$

where q₀ and \vec{q} are the scalar and the vector portions of the quaternion, respectively.

The representation of Euler angles is comprised of three rotations [10]:

a rotation φ around the x-axis (roll angle)

a rotation θ around the y-axis (pitch angle)

a rotation ψ around the z-axis (yaw angle)

The rotation matrix is a 3×3 matrix that represent the three-unit vectors yielding 9 parameters used for attitude estimation.

Each of the three attitude representations has their advantages and disadvantages. For example, the Euler angle representation is subject to the gimbal-lock problem [10], and the rotation matrix contains 9 values that need to be determined, and quaternions are less intuitive to read and interpret. However, the quaternion representation avoids the singularity problem that is given by the Euler angles and in addition quaternions involve simple computations and thus can be operated on a large number of applications.

MIMU Sensor and/or Virtual IMU. The MIMU system could be composed of an array of IMUs where each IMU component integrates a 9-axis combination of 1 accelerometer, 1 gyroscope and 1 magnetometer. Alternatively the MIMU system could be composed of separate arrays of individual accelerometers, individual gyroscopes and individual magnetometers, or any combination for 2 types of sensors with a third individual sensor.

The Magnetic and Inertial Measurement Unit (MIMU) is composed of MEMS (Micro-Electro-Mechanical Systems) sensors that consists of a 3-axis accelerometer, a 3-axis gyroscope, and a 3-axis magnetometer. The sensor outputs of these low-cost sensors are not very good, meaning that they suffer from several problems such as noise, bias, scale factor, axis misalignment, axis non-orthogonality and local temperature [12].

1) Gyroscope:

The gyroscope measures the angular velocity of the tracking object in rad/s and is represented by:

[s_{wx} s_{wy} s_{wx}]^{T}. The gyroscope measurements suffer from:
angular random walk
bias instability
rate random walk

The continuous time model for a gyroscope can be expressed such as:

s_{w}=s_{w}_{ᵣ}+s_{w}_{_{b}}+s_{w}_{ₙ} (2)
where s_{w} is the angular rate measured by the gyroscope, s_{wr} is the true angular rate, s_{wb} is the gyroscope bias that models its derivative by a random walk noise, and s_{wn} is the white noise of the gyroscope.

The gyroscope measurements are not enough for attitude estimation and thus additional sensors such as accelerometers and magnetometer can compensate this drift. The accelerometer corrects the pitch and roll angles, and the magnetometer improves the yaw angle.

2) Accelerometer:

The accelerometer measures the sum of the gravity and external acceleration of the tracking object in m/s². The acceleration is given as sₐ=[sₐₓ s_{ay} s_{az}]^{T}. As for the accelerometer measurements, the three main types of noise are:
velocity random walk
bias instability
correlated noise

The continuous time model of the accelerometer can be summarized as:

sₐ=sₐ_{ᵣ}+sₐ_{_{b}}+sₐ_{ₙ} (3)
where sₐ is the sum of the gravity and external acceleration of the tracking object, sₐᵣ is the sum of the gravity and external acceleration, s_{ab} is the accelerometer bias that models its derivative by a Gauss-Markov noise, sₐₙ is the accelerometer white noise.

3) Magnetometer:

The magnetometer measures the magnetic field of the tracking object in μT, and is represented as sₘ=[sₘₓ s_{my} s_{mz}]^{T}. The Earth's magnetic field is modeled by a dipole and follows the basic laws of magnetic fields. At any location, the Earth's magnetic field can be represented by a three-dimensional vector. Please refer to [17] for more information.

The three types of noise of the magnetometer are:
angle random walk
bias instability
correlated noise

The continuous time model of the magnetometer is represented as:

sₘ=sₘ_{ᵣ}+sₘ_{_{b}}+sₘ_{ₙ} (4)
where sₘ is the magnetic field measured by the magnetometer, sₘᵣ is the true magnetic field, s_{mb} is the bias of the magnetometer where its derivate is modeled by a Gauss-Markov noise, and sₘₙ is the white noise.

The magnetometer does not only measure the Earth's magnetic field, it is also influenced by magnetic disturbances caused by ferromagnetic objects in the environment.

Past research has shown that redundant MIMUs are an efficient way to improve navigation performances. However, the precise relationship between the number of sensors employed and the accuracy enhancement remains unclear and none of the research work offers guidance as to how many sensors are required to achieve a specific accuracy.

Different MIMU sensor array configurations were evaluated by scaling the numbers of sensors used. Simulation experiments were carried out using ground truth acceleration, rotation, and magnetometer data. The evaluation was done using the readings from each sensor in the virtual frame averaged from the resulting accelerometer, gyroscope, and magnetometer and fused by a filter, such as an IMU filter or Madgwick filter, to obtain an orientation estimate. A root mean square error (RMSE) was calculated based on the estimated Euler angles and compared to the orientation RMSE of a single MIMU centered at the origin of the system.

Ground truth acceleration, rotation, and magnetometer data is used in the present invention. This data is randomly rotated accordingly to simulate each IMU's location in the system. Noise and bias are added as specified in [1]. The readings from each sensor in the virtual frame are averaged and the resulting accelerometer, gyroscope, and magnetometer are fused in the Madgwick filter to obtain an orientation estimate. A root mean square error (RMSE) is calculated based on the estimated Euler angles and compared to the orientation RMSE of a single IMU centered at the origin of the system. In addition, the parallelization of the code is done using multiple cores instead of only one in order to speed up the Euler angle estimation of the Madgwick filter and to investigate the effect of the scaling of the number of sensors. Thus, the execution times are recorded in order to observe the efficiency of the parallel over the sequential implementation.

### BRIEF DESCRIPTION OF THE DRAWINGS

The presently-disclosed subject matter will be better understood, and features, aspects and advantages other than those set forth above will become apparent when consideration is given to the following detailed description thereof. Such detailed description makes reference to the following drawings, wherein:

FIG. 1 shows a block diagram of a Madgwick Filter.

FIG. 2 shows sensor data obtained by the gyroscope, accelerometer, and magnometer. For the gyroscope, the largest amplitude positive and negative is Y, the negative amplitude followed by double positive peaks is Z, and X is a small positive amplitude followed by a small negative amplitude, followed by a small positive amplitude and a small negative amplitude. For the accelerometer, Z is the top tracing, Y is the middle tracing, and X is the bottom racing. The normal tracing represented by the dotted line most closely parallels Z. For the magnetometer, A is the top tracing, Y is the middle tracing, and Z the bottom tracing.

FIG. 3 shows RMSE values in X, Y, Z directions with increasing numbers of sensors. Y is the top line, X is the middle line, and Z is the bottom line.

FIG. 4 shows norm RMSE value with increasing numbers of sensors.

FIG. 5 shows execution time of increasing number of sensors for sequential execution.

FIG. 6 shows execution time of increasing number of sensors for parallel versus sequential execution. The top upward trending line represents sequential execution time. The bottom line represents parallel execution time.

FIG. 7 shows execution time of increasing number of sensors for parallel version.

FIG. 8 shows execution time of multiple of 16 sensor increments for parallel version.

While the disclosure is susceptible to various modifications and alternative forms, specific embodiments thereof have been shown by way of example in the drawings and are herein described below in detail. It should be understood, however, that the description of specific embodiments is not intended to limit the disclosure to cover all modifications, equivalents and alternatives falling within the spirit and scope of the disclosure as defined by the appended claims.

### DESCRIPTION OF EXEMPLARY EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

Unless defined otherwise, all technical and scientific terms used herein have the same meaning as commonly understood by one of ordinary skill in the art to which the presently-disclosed subject matter belongs. Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims. For example, reference to “a device” includes a plurality of devices, and so forth.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, length, width, weight, time, volume, concentration or percentage is meant to encompass variations of in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “approximately” are used interchangeably and carry the same meaning.

While the following terms used herein are believed to be well understood by one of ordinary skill in the art, definitions are set forth to facilitate explanation of the presently-disclosed subject matter.

Attitude Estimation Algorithms

The overall design of attitude estimation filters is described below followed by a thorough description of the Madgwick Filter [13].

Filter Design

The two algorithms are described using common notations used for quaternion and sensor readings. The estimated vector v is described by \hat{v}=[\hat{v}ₓ \hat{v}_{y} \hat{v}_{z}]^{T}, the quaternion and angular rate errors are given by qₑ, wₑ, and the time difference between 2 epochs is Δt.

The two filter algorithms use two reference vectors Eₐ and Eₘ in order to estimate q. In a noise-free environment, the relation between these two reference vectors are given as:

s_{q}_{_{q}}=q⁻¹⊗E_{q}_{_{q}}⊗q (5)

where ⊗ is the quaternion multiplication [9]. s_{aq} is the quaternion form of sₐ, which can be written as S_{aq}=[0 sₐₓ s_{ay} s_{az}]^{T}. E_{aq} is the quaternion form of Eₐ. For the static case it is Eₐ=[0 0 g]^{T} where g is the acceleration due to gravity (g≈9.8 m/s²).

In a perfect environment, one that is noise-free as well as there is no magnetic deviation, the relation between Eₘ and sₘ is the following:

sₘ_{_{q}}=q⁻¹⊗Eₘ_{_{q}}⊗q (6)

where s_{mq} is the quaternion form of sₘ, which can be written as s_{mq}=[0 sₘₓ s_{my} S_{mz}]^{T}. E_{mq} is the quaternion form of Eₘ. If there are no magnetic deviations, Eₘ can be calculated using [14].

The kinematic equation of a rigid body is defined by angular velocity measurements from a gyroscope to describe the variations of the attitude in terms of quaternions as such:

\dot{q}=½q⊗s_{w}_{_{q}} (7)

where s_{wq} is the quaternion of s_{w}.

Madgwick Filter

The algorithm of the Madgwick filter is shown in Algorithm 1. Madgwick is a gradient descent based algorithm where the quaternion error from the gradient descent algorithm provides also a gyroscope drift compensation. In the algorithm, Jₜ is the Jacobian Matrix of Fₜ, β is the divergence rate of qₜ representing the magnitude of a quaternion derivative corresponding to the gyroscope measurement error, and ζ is the integral gain.

Alogorithm 1 Madgwick Filter [13]

${E}_{{\hat{h}}_{q , t}} = {\hat{q}}_{t - 1} ⊗ {s}_{{m}_{q , t}} ⊗ {\hat{q}}_{t - 1}^{- 1}$
${E}_{{\hat{m}}_{q , t}} = {[ \begin{matrix}0 & 0 & \sqrt{{E}_{{\hat{h}}_{x , t}^{2}} + {E}_{{\hat{h}}_{y , t}^{2}}} & {E}_{{\hat{h}}_{z , t}}\end{matrix} ]}^{T}$
${F}_{t} = [ \begin{matrix}{\hat{q}}_{t - 1}^{- 1} ⊗ {E}_{{a}_{q , t}} ⊗ {\hat{q}}_{t - 1} - {s}_{{a}_{q , t}} \\ {\hat{q}}_{t - 1}^{- 1} ⊗ {E}_{{m}_{q , t}} ⊗ {\hat{q}}_{t - 1} - {s}_{{m}_{q , t}}\end{matrix} ]$
\hat{q}_{e,t} = Jₜ^{T}Fₜ
${s}_{{\hat{w}}_{a , t}} = 2 {\hat{q}}_{t - 1} ⊗ {\hat{q}}_{e , t}$
${s}_{{\dot{\hat{w}}}_{b , t}} = {s}_{{w}_{e , t}}$
${s}_{{\hat{w}}_{t}} = {s}_{{w}_{t}} - Ϛ {s}_{{w}_{b , t}}$
${\dot{\hat{q}}}_{t} = \frac{1}{2} {\hat{q}}_{t - 1} ⊗ {s}_{{\hat{w}}_{q , t}} - β \frac{{\hat{q}}_{e , t}}{‖ {\hat{q}}_{e , t} ‖}$

Additional Filters

It is understood in the art that filters other than Madgwick filters may be used in the present invention. Non-limiting examples of other filters include Mahony filters, Kalman filters, and extended Kalman filters. It is well known that these filters have the capacity to be implemented in a parallel process on a processing unit.

### EMBODIMENTS

The presently-disclosed subject matter meets some or all of the above-identified needs, as will become evident to those of ordinary skill in the art after a study of information provided in this document.

This summary describes several embodiments of the presently-disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently-disclosed subject matter, whether listed in this summary or not. To avoid excessive repetition, this summary does not list or suggest all possible combinations of features.

The present disclosure is directed towards a system of navigation as well as a method for navigation containing a plurality of computing cores.

In one embodiment, the present disclosure is directed to a system for navigation comprising: a computing machine having a plurality of computing cores and an input/output interface; and a plurality of Magnetic and Inertial Measurement Units (MIMUs), the plurality of MIMUs positioned to form a sensor array, each of the plurality of MIMUs in communication with the input/output interface of the computing machine and generating relative accelerometer, gyroscope, and magnetometer data; wherein the computing machine: receives the relative accelerometer, gyroscope, and magnetometer data of the plurality of MIMUs; and fuses the resulting accelerometer, gyroscope, and magnetometer data using a Madgwick filter to obtain an orientation value; wherein the actions of the computing machine are parallelized using the plurality of computing cores.

In other embodiments, the present disclosure is directed to a system for navigation comprising: a computing machine having a plurality of computing cores, a built-in memory, a plurality of digital processing cores, a plurality of Field Programmable Gate Arrays and an input/output interface; and a plurality of Magnetic and Inertial Measurement Units (MIMUs), the plurality of MIMUs positioned to form a sensor array, each of the plurality of MIMUs in communication with the input/output interface of the computing machine and generating relative accelerometer, gyroscope, and magnetometer data; wherein the computing machine: receives the relative accelerometer, gyroscope, and magnetometer data of the plurality of MIMUs; and fuses the resulting accelerometer, gyroscope, and magnetometer data using a filter selected from one or more of: a Madgwick filter, a Mahony filter, a Kalman Filter and an extended Kalman filter, to obtain an orientation value; wherein the actions of the computing machine are parallelized using the plurality of computing cores; and wherein the parallel action of the computing machine allows an optimization of the plurality of MIMU's number and a substantial optimization of the processing time for the plurality of MIMUs, in addition to a minimum accuracy improvement of 25% for a Virtual IMU.

In further embodiments of the present disclosure, the plurality of MIMUs/sensor arrays equal in number the plurality of computing cores.

In other embodiments of the present disclosure, the filters are a Kalman filter and an extended Kalman filter and the parallel action of the computing machine enables parallel implementation of Kalman filter code and extended Kalman filter code to accelerate the fusion process.

In a further embodiment of the present disclosure, the Madgwick filter comprises: a correction method to align gyroscope measurements depending on a parameter; a quaternion propagation method using the result of the correction method and an orientation estimated at a previous step; and gradient descent method which fuses the relative accelerometer and magnetometer data using an adjustable parameter, β: wherein the output of the gradient descent method is used to correct the orientation estimated by the quaternion propagation method using the gyroscope measurements only.

Another embodiment of the present disclosure includes a method for navigation comprising: receiving, by a computing machine having a plurality of computing cores, relative accelerometer, gyroscope, and magnetometer data of a plurality of Magnetic and Inertial Measurement Units (MIMUs) positioned to form a sensor array; and fusing, by the computing machine, the resulting accelerometer, gyroscope, and magnetometer data using a Madgwick filter to obtain an orientation value; wherein the actions of the computing machine are parallelized using the plurality of computing cores.

Another embodiment of the present disclosure includes a method for navigation comprising: receiving, by a computing machine having a plurality of computing cores, a plurality of digital processing cores, a plurality of Field Programmable Gate Arrays and a plurality of built-in memory, relative accelerometer, gyroscope, and magnetometer data of a plurality of Magnetic and Inertial Measurement Units (MIMUs) positioned to form a sensor array; and fusing, by the computing machine, the resulting accelerometer, gyroscope, and magnetometer data using a filter selected from a set of a Madgwick filter, a Mahony filter, a Kalman Filter and an Extended Kalman Filter to obtain an orientation value for a virtual IMU; wherein the actions of the computing machine are parallelized using the plurality of computing cores; and wherein the parallel action of the computing machine allows an optimization of the plurality if MIMUs number, a substantial optimization of the processing time for the plurality of MIMUs, in addition to a minimum accuracy improvement of 25% for the resulting Virtual IMU.

In a further embodiment of the present disclosure, the plurality of MIMUs equal in number the plurality of computing cores.

In some embodiments of the present invention, the Madgwick filter comprises: aligning gyroscope measurements depending on a parameter; using the result of the correction method and an orientation estimated at a previous step to determine orientation estimated by a quaternion propagation method; fusing the relative accelerometer and magnetometer data using an adjustable parameter, B, in a gradient descent method; and using the output of the gradient descent method to correct the orientation estimated by the quaternion propagation method.

Additional features and advantages of the systems and methods of the present disclosure will become evident to those of ordinary skill in the art after a study of the description, figures, and non-limiting examples in this document.

### Examples

### Example 1

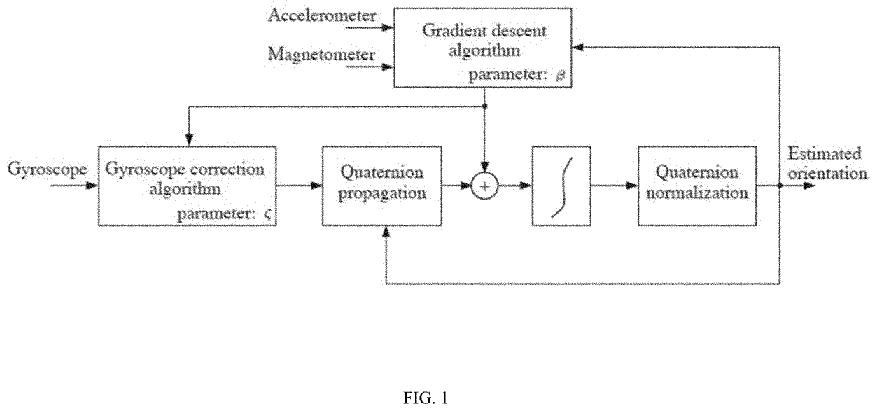

FIG. 1 shows the block diagram of the Madgwick filter. Two main processes are used to compute the orientation of the rigid body. First, a correction algorithm is used to align the gyroscope measurements depending on the parameter. To minimize the effects that are due to the bias and the drift error, both are used to compute the body orientation via the quaternion propagation beginning from the orientation estimated at the previous step. Then, both the accelerometer and magnetometer measurements are fused together using an adjustable parameter, ß, via the gradient descent algorithm as described in [10]. The output of the gradient descent algorithm is then used to correct the orientation estimated by considering the gyroscope measurements only.

MIMU Simulation Configuration Experiments

This section contains the description of the data that was used for the simulation experiments. The data provides ground-truth euler angles so that the accuracy of the Madgwick AHRS can be evaluated.

Simulation Environment

The code was implemented with Matlab using version R2017A. The machine that facilitated the experiments consisted of 16 cores/32 thread machine with Intel® Xeon® CPU E5-2680 @ 2.70 GHz with 32 GB of RAM.

Data Description

The data used is foot mounted MIMU measurement data [15]. It contains sensor data of a straight trajectory of 1,000 steps based on a human step pattern characteristics measured by a motion capture system. Only partial set of the data set was used. The information from the MIMU is the acceleration, turn rates from the gyroscope and the magnetic field. The data set includes the orientation (Euler and DCM) ground truth values. The units are in meters, seconds and radians, a sampling frequency of 100 Hz was used, and gravity is 9.8 m/s². The MIMU used was the XSense Mti with the following specification:

Accelerometer: 0.012 m/s² standard deviation random noise and a random constant with a Gaussian distribution and a standard deviation of 0.04 m/s² for the bias.

Gyroscope: 0.0087 rad/s standard deviation random noise and a random constant with a Gaussian distribution and a standard deviation of 0.015 rad/s for the bias.

XSense MIMU are commonly used in motion sensing applications, and are seen as the gold standard for scientific research [16]-[19].

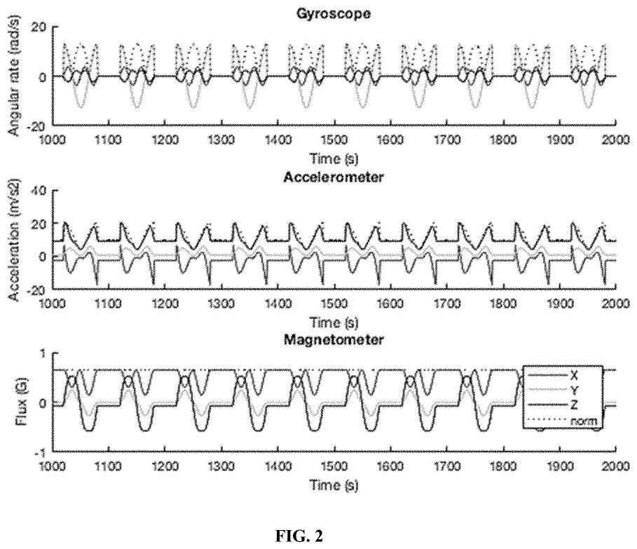

FIG. 2 shows the sensor data obtained by the gyroscope, accelerometer, and magnetometer. The cyclic steps of the walking motion can be observed.

Simulation Experiments

For the evaluation, the following experiments were run to:

Investigate the RMSE values for increasing numbers of sensors;

Investigate the execution time for the sequential execution of the code (normal implementation) for increasing numbers of sensors;

Investigate the execution time for the parallel execution of the code for increasing numbers of sensors including multiples of 16 (since 16 cores are available on the machine).

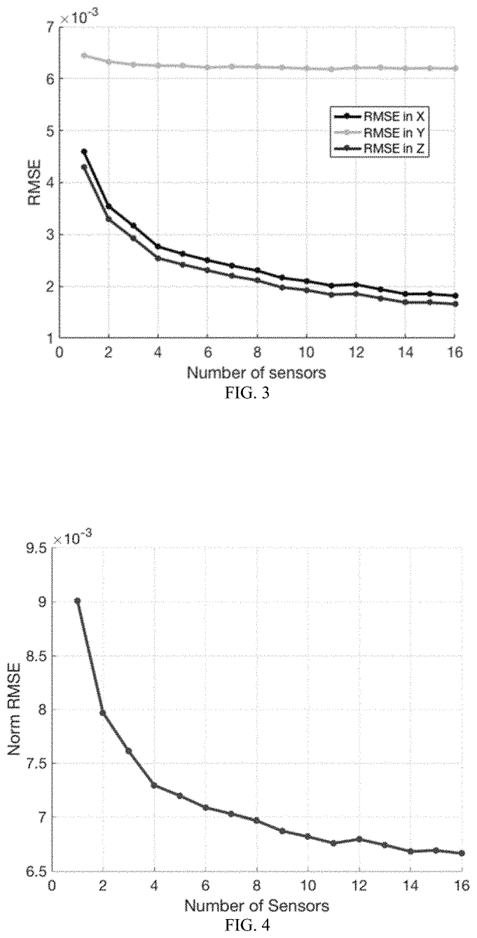

First, the Madgwick AHRS implementation was run and the RMSE (Root Mean Square Error) values of the estimated Euler angles in x-, y-, and z-direction with increasing numbers of sensors starting from one sensor up to 16 sensors were observed. FIG. 3 shows the RMSE values exponentially decreasing for all three axes with increasing numbers of sensors.

FIG. 4 shows the norm RMSE based on the three RMSE values of the three directions. The exponential trend of the norm RMSE is well observed.

Table 1 tabulates the results as plotted in FIG. 3 and FIG. 4. Based on the norm RMSE values, the relative improvement can be calculated as shown in Table 2. The relative improvement using 2 sensors is 11.54% whereas an improvement of 26.01% is achieved using 16 sensors. The exponential downward trend seen in the norm RMSE values can also be observed by the relative improvement values for increasing numbers of sensors.

TABLE 1
RMSE in X, Y, Z Direction and Norm RMSE with
increasing numbers of sensors

| Number | | | | |
|---|---|---|---|---|
| of | | | | norm |
| sensors | RMSE_X | RMSE_Y | RMSE_Z | RMSE |
| 1 | 0.004594 | 0.0064458 | 0.0042995 | 0.0090077 |
| 2 | 0.0035468 | 0.0063283 | 0.0032958 | 0.007968 |
| 3 | 0.003168 | 0.0062713 | 0.0029274 | 0.0076115 |
| 4 | 0.0027652 | 0.0062521 | 0.0025443 | 0.0072944 |
| 5 | 0.0026259 | 0.0062473 | 0.0024215 | 0.0071964 |
| 6 | 0.0025034 | 0.0062161 | 0.0023076 | 0.0070874 |
| 7 | 0.0023966 | 0.0062313 | 0.0021983 | 0.0070289 |
| 8 | 0.0023042 | 0.0062262 | 0.0021151 | 0.0069677 |
| 9 | 0.0021632 | 0.0062143 | 0.0019802 | 0.0068715 |
| 10 | 0.0021009 | 0.006195 | 0.001927 | 0.0068195 |
| 11 | 0.002016 | 0.0061833 | 0.0018408 | 0.0067591 |
| 12 | 0.0020363 | 0.0062115 | 0.001856 | 0.0067951 |
| 13 | 0.0019402 | 0.0062095 | 0.0017707 | 0.0067422 |
| 14 | 0.001852 | 0.006194 | 0.0016896 | 0.0066821 |
| 15 | 0.0018529 | 0.0062048 | 0.001687 | 0.0066917 |
| 16 | 0.0018191 | 0.0061931 | 0.0016584 | 0.0066644 |

TABLE 2
Relative Improvement in RMSE with
increasing numbers of sensors

| Number of sensors | Improvement in % |
|---|---|
| 2 | 11.54 |
| 3 | 15.50 |
| 4 | 19.02 |
| 5 | 20.11 |
| 6 | 21.32 |
| 7 | 21.97 |
| 8 | 22.65 |
| 9 | 23.72 |
| 10 | 24.29 |
| 11 | 24.96 |
| 13 | 25.15 |
| 14 | 25.82 |
| 15 | 25.71 |
| 16 | 26.01 |

During the simulation experiments it was observed that the running time increases exponentially with the increase in the number of sensors; FIG. 5 shows this trend.

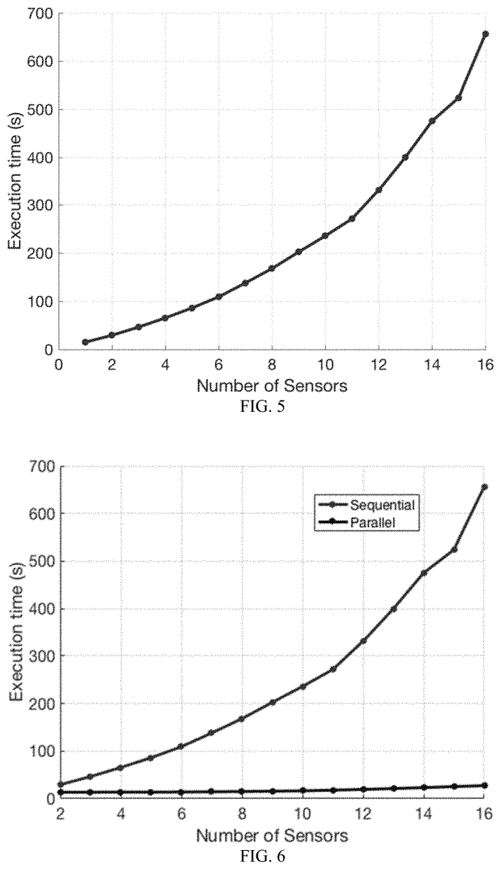

The exponential trend of the execution times for increasing numbers of sensors led us to parallelize the simulation code and move away from the sequential execution to a parallel execution to estimate the euler angles. FIG. 6 shows the sequential and parallel execution times with increasing numbers of sensors. As can be seen by the figure, the parallel execution time is quite steady. The values are also provided in Table 3.

TABLE 3
Execution times in seconds for sequential and parallel version

| Sensors | 1 | 2 | 3 | 4 | 5 | 6 | 7 | 8 |
|---|---|---|---|---|---|---|---|---|
| Sequential | 15.10 | 20.41 | 46.43 | 65.44 | 86.06 | 109.12 | 137.88 | 167.92 |
| Parallel | 13.48 | 13.50 | 13.66 | 13.88 | 13.89 | 14.03 | 14.55 | 14.99 |
| Sensors | 9 | 10 | 11 | 12 | 13 | 14 | 15 | 16 |
| Sequential | 02.27 | 235.70 | 271.15 | 330.90 | 399.70 | 475.34 | 524.00 | 655.98 |
| Parallel | 15.77 | 16.43 | 17.91 | 19.45 | 21.28 | 23.25 | 25.47 | 27.36 |

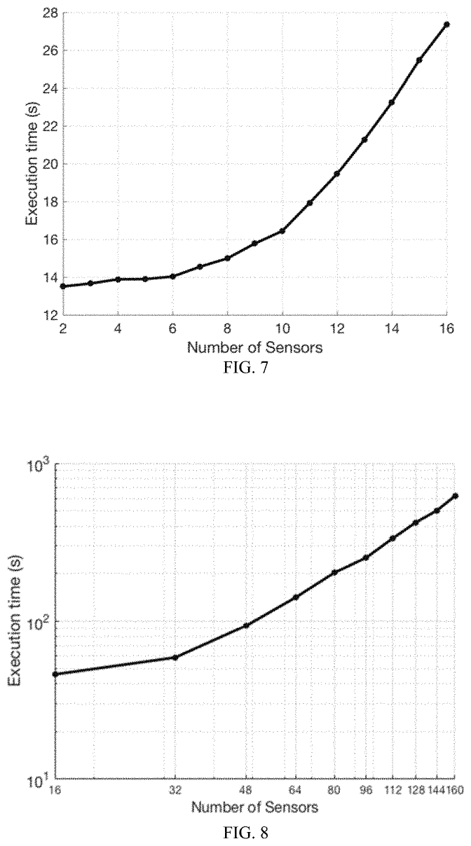

Zooming in on the parallel execution times, as shown in FIG. 7, an exponential trend is apparent, however, nothing compared to the sequential execution times.

Since 16 cores are available, simulations with multiples of 16 sensors (from 16 to 160 sensors) were run to observe the trend in the execution time of the parallel implementation further. FIG. 8 shows the results; the execution times in double logarithmic scale show a linear trend for the multiples of 16 sensors from 32 sensors onwards.

The simulation experiments revealed the following. Based on the norm RMSE values, the relative improvement using 2 sensors is 11.54% whereas an improvement of 26.01% is achieved using 16 sensors. However, the execution time exponentially increases with every sensor added to the orientation estimation. Thus, a parallel version using a multi-core machine was implemented. Using a 16-core machine and running the orientation estimation using the Madgwick filter, the findings of the sixteen sensor configuration were that the execution time is less than twice the execution time of running a one sensor configuration, and 24 times less than using the sequential version with the added benefit of a 26% increase in accuracy.

The results of the simulation relative to a substantial increase in accuracy as measured by Allen Variances, coupled with a minimal increase in processing time were confirmed by the tests implemented with the prototype that was developed by Axelo Inc.

In testing an array configuration of 16 IMU and comparing it to one single IMU, the following results were obtained, clearly showing a substantial improvement in accuracy when using the 16 IMU array, as compared to operation with one single IMU (Tables 4 and 5).

TABLE 4
Accuracy of 16 IMU array versus 1 IMU array

| | Velocity Random Walk (m/s/√hr) | | | Bias instability (mg) | | |
|---|---|---|---|---|---|---|
| | | 8 + 8 | | | 8 + 8 | |
| Axis | 16 on Top | (mirrored) | Single | 16 on Top | (mirrored) | Single |
| X | 0.027 | 0.059 | 0.096 | 0.029 | 0.029 | 0.093 |
| Y | 0.037 | 0.037 | 0.096 | 0.030 | 0.032 | 0.084 |
| Z | 0.038 | 0.045 | 0.147 | 0.044 | 0.039 | 0.143 |

TABLE 5
Accuracy of 16 IMU array versus 1 IMU array

| | Anglr Random Walk (deg/√hr) | | | Bias Instability (deg/hr) | | |
|---|---|---|---|---|---|---|
| | | 8 +8 | | | 8 + 8 | |
| Axis | 16 on Top | (mirrored) | Single | 16 on Top | (mirrored) | Single |
| X | 0.166 | 0.213 | 0.572 | 3.215 | 3.736 | 11.696 |
| Y | 0.198 | 0.226 | 0.585 | 4.237 | 4.648 | 14.555 |
| Z | 0.163 | 0.194 | 0.616 | 3.496 | 1.85 | 11.056 |

The testing also confirmed that the processing time for an array of 16 IMU would have a minimal processing time increase when compared to the processing time of one single IMU (Table 6).

TABLE 6
Processing time of 16 IMU array versus 1 IMU array

| Number of | IMU | Processing Time @ | Number of |
|---|---|---|---|
| IMUs | access time | 64 MHz system | System |
| selected | (msec) | clock (msec) | Clock cycles |
| 1 | 1.2 | 1.2 | 82816 |
| 16 | 1.2 | 1.6 | 102400 |

### INCORPORATION BY REFERENCE

All publications, patents, and patent applications mentioned in this specification are herein incorporated by reference to the same extent as if each individual publication, patent, or patent application was specifically and individually indicated to be incorporated by reference.

It will be understood that various details of the presently disclosed subject matter can be changed without departing from the scope of the subject matter disclosed herein. Furthermore, the foregoing description is for the purpose of illustration only, and not for the purpose of limitation.

### REFERENCES

Each of the following references is herein incorporated by reference in their entirety.
[1] E. Munoz Diaz, O. Heirich, M. Khider, P. Robertson, Optimal sampling frequency and bias error modeling for foot-mounted IMUs, 2013 International Conference on Indoor Positioning and Indoor Navigation (IPIN), Montbeliard-Belfort, France, 2013.
[2] A. Lennartsson, D. Skoogh, Sensor redundancy for inertial navigation, Technical report, FOI (Swedish Defense Research Agency), SE, 2003.
[3] S. Sukkarieh, P. Gibbens, B. Grocholsky, K. Willis, H. Durrant Whyte, A low-cost, redundant inertial measurement unit for unmanned air vehicles, Int. J. Robot. Res. 19(11), 10891103, 2000.
[4] M. Jafari, Optimal redundant sensor configuration for accuracy increasing in space inertial navigation system, Aerospace Science and Technology, Volume 47, December 2015.
[5] H. Martin, P. Groves, M. Newman, R. Faragher, A New Approach to Better Low-Cost MEMS IMU Performance Using Sensor Arrays, Proceedings of the 26th International Technical Meeting of The Satellite Division of the Institute of Navigation (ION GNSS 2013), Nashville, Tex., USA, 2013.
[6] A. Waegli, S. Guerrier, and J. Skaloud, Redundant MEMS-IMU integrated with GPS for Performance Assessment in Sports, in Proceedings of the IEEE/ION PLANS 2008, Monterey, Calif., USA, 2008.
[7] S. Guerrier, Improving Accuracy with Multiple Sensors: Study of Redundant MEMS-IMU/GPS Configurations, Proceedings of the 22nd International Technical Meeting Of The Satellite Division Of The Institute Of Navigation, 2009.
[8] S. Guerrier, Integration of Skew-Redundant MEMSIMU with GPS for Improved Navigation Performance, Master's thesis, EPFL, 2008.
[9] A. Waegli, Trajectory Determination and Analysis in Sports by Satellite and Inertial Navigation, Ph.D. dissertation, Thesis 4288, EPFL, 2009.
[10] S. Sukkarieh, P. Gibbens, B. Brocholsky, K. Willis, and H. Durrant-Whyte, A Low-Cost Redundant Inertial Measurement Unit for Unmanned Air Vehicles, The International Journal of Robotics Research, vol. 19, no. 11, pp. 10891103, 2000.
[11] A. Osman, B. Wright, S. Nassar, A. Noureldin, and N. El-Sheimy, Multi-Sensor Inertial Navigation Systems Employing Skewed Redundant Inertial Sensors, in Proceedings of the ION GNSS 2006, Fort Worth, Tex., USA, 2006.
[12] T. Michel, H. Fourati, P. Geneves, N. Layada. A Comparative Analysis of Attitude Estimation for Pedestrian Navigation with Smartphones. 2015 International Conference on Indoor Positioning and Indoor Navigation, Banff, Canada, October 2015.
[13] S. O. Madgwick, A. J. Harrison, and R. Vaidyanathan, Estimation of IMU and MARG orientation using a gradient descent algorithm, in 2011 IEEE International Conference on Rehabilitation Robotics (ICORR), 2011.
[14] NGA and the U.K.'s Defence Geographic Centre (DGC), The world magnetic model, http://www.ngdc.noaa.gov/geomag/WMM, 2015, [Online; last accessed December 2017].
[15] Foot Mounted IMU data sets for the evaluation of PDR algorithms, LOPSI Research group, Spain, http://lopsi.weebly.com/downloads.html, 2017.
[16] A. G. Cutti, A. Giovanardi, L. Rocchi, A. Davalli, R. Sacchetti, Ambulatory measurement of shoulder and elbow kinematics through inertial and magnetic sensors. Med. Boil. Eng. Comput., 46, 169-178, 2008.
[17] W. M. Chung, S. Yeung, W. W. Chan, R. Lee, Validity of VICON Motion Analysis System for Upper Limb Kinematic Measurement A Comparison Study with Inertial Tracking Xsens System. Hong Kong Physiother. J. 2011.
[18] D. Hamacher, D. Bertram, C. Folsch, L. Schega, Evaluation of a visual feedback system in gait retraining: A pilot study. Gait Posture, 36, 182-186, 2012.
[19] K. Saber-Sheikh, E. C. Bryant, C. Glazzard, A. Hamel, R. Y. Lee, Feasibility of using inertial sensors to assess human movement. Man. Ther., 15, 122-125, 2010.

What is claimed is:

1. A system for navigation, comprising:
a computing machine having a plurality of computing cores, a built-in memory, a plurality of digital processing cores, a plurality of Field Programmable Gate Arrays and an input/output interface; and
a plurality of Magnetic and Inertial Measurement Units (MIMUs), the plurality of MIMUs positioned to form a sensor array, each of the plurality of MIMUs in communication with the input/output interface of the computing machine and generating relative accelerometer, gyroscope, and magnetometer data;
wherein the computing machine:
receives the relative accelerometer, gyroscope, and magnetometer data of the plurality of MIMUs; and
fuses the resulting accelerometer, gyroscope, and magnetometer data using a filter selected from one or more of: a Madgwick filter, a Mahony filter, a Kalman Filter and an extended Kalman filter, to obtain an orientation value;
wherein the actions of the computing machine are parallelized using the plurality of computing cores; and
wherein the parallel action of the computing machine allows an optimization of the plurality of MIMU's number and a substantial optimization of the processing time for the plurality of MIMUs, in addition to a minimum accuracy improvement of 25% for a Virtual IMU.

2. The system of claim 1, wherein the plurality of MIMUs equal in number the plurality of computing cores.

3. The system of claim 1, wherein the filters are a Kalman filter and an extended Kalman filter and the parallel action of the computing machine enables parallel implementation of Kalman filter code and extended Kalman filter code to accelerate the fusion process.

4. The system of claim 1, wherein the Madgwick filter comprises:
a correction method to align gyroscope measurements depending on a parameter;
a quaternion propagation method using the result of the correction method and an orientation estimated at a previous step; and
gradient descent method which fuses the relative accelerometer and magnetometer data using an adjustable parameter, β:
wherein the output of the gradient descent method is used to correct the orientation estimated by the quaternion propagation method using the gyroscope measurements only.

5. The system of claim 1, wherein the Madgwick filter comprises:
aligning gyroscope measurements depending on a parameter;
using the result of the correction method and an orientation estimated at a previous step to determine orientation estimated by a quaternion propagation method;
fusing the relative accelerometer and magnetometer data using an adjustable parameter, ß, in a gradient descent method; and
using the output of the gradient descent method to correct the orientation estimated by the quaternion propagation method.

6. A method for navigation comprising:
receiving, by a computing machine having a plurality of computing cores, a plurality of digital processing cores, a plurality of Field Programmable Gate Arrays and a plurality of built-in memory, relative accelerometer, gyroscope, and magnetometer data of a plurality of Magnetic and Inertial Measurement Units (MIMUs) positioned to form a sensor array; and
fusing, by the computing machine, the resulting accelerometer, gyroscope, and magnetometer data using a Madgwick filter to obtain an orientation value for a virtual IMU;
wherein the actions of the computing machine are parallelized using the plurality of computing cores; and
wherein the parallel action of the computing machine allows a substantial optimization of the processing time for the plurality of MIMUs, in addition to a minimum accuracy improvement of 25% for the Virtual IMU.

7. The method of claim 6, wherein the plurality of MIMUs equal in number the plurality of computing cores.
